(19) United States
(12) Patent Application Publication
(10) Pub. No.: US 2017/0220858 A1
(43) Pub. Date: Aug. 3, 2017

(54) OPTICAL RECOGNITION OF TABLES

(71) Applicant: Microsoft Technology Licensing, LLC, Redmond, WA (US)

(72) Inventors: Anya Stitz, Seattle, WA (US); John Campbell, Woodinville, WA (US); Catherine Neylan, Seattle, WA (US); Dusan Lukic, Belgrade (RS); Ivan Vujic, Belgrade (RS); Christopher C. Yu, Irvine, CA (US); Igor Borisov Peev, Arlington, WA (US); Shangwei Fang, Issaquah, WA (US)

(73) Assignee: Microsoft Technology Licensing, LLC, Redmond, WA (US)

(21) Appl. No.: 15/420,647

(22) Filed: Jan. 31, 2017

Related U.S. Application Data
(60) Provisional application No. 62/289,834, filed on Feb. 1, 2016.

(51) Int. Cl. G06K 9/00; G06F 17/21; G06K 9/62; G06F 17/24; G06T 7/00; G06T 11/60

(52) U.S. Cl. CPC G06K 9/00456; G06T 7/0002; G06T 11/60; G06K 9/6256; G06F 17/245; G06F 17/211; G06F 17/246; G06K 2209/01

(57) ABSTRACT

The present disclosure is directed to a method for optically recognizing a table and converting that recognized table to a digitized format. In particular, the present disclosure relates to a method of optically recognizing and identifying a table generally, individual cells within the table, the data embedded within each cell, as well as the original table format, including shading, cell borders, colors, and effects. Accordingly, such digitization of an optically recognized table, in whole or in part, as printed on a document or other media allows users to easily and quickly capture information as originally arranged without having to manually re-create a table and enter data into the re-created table.

### CROSS-REFERENCE TO RELATED APPLICATIONS

The present application claims priority to U.S. Provisional Patent Application No. 62/289,834, filed Feb. 1, 2016 and entitled “Optical Recognition of Tables,” the disclosure of which is hereby incorporated by reference in its entirety.

Details regarding the present disclosure are also provided in U.S. Patent Application Serial No. 2013/0191715, entitled “Borderless Table Detection Engine” filed on Jan. 23, 2012; and U.S. Patent Application Serial No. 2015/0262007, entitled “Detecting And Extracting Image Document Components to Create Flow Document,” filed Mar. 11, 2014, the entireties of which are hereby incorporated by reference.

### BACKGROUND

Optical character recognition (“OCR”) is a technology that is particularly useful for converting handwritten or other printed text to machine recognizable, digitized text. Such digitized text is useful for searching, editing, and notetaking purposes. However, current OCR methods are limited in capability, recognizing only text, including letters, numbers, and symbols. Although relatively specific problems are discussed, it should be understood that the aspects should not be limited to solving only the specific problems identified in the background.

### SUMMARY

In a first aspect, disclosed is a computer-implemented method for optically recognizing a table using an optical recognition application, the method comprising: receiving an image of an original table; recognizing one or more aspects of the original table; and generating a digitized table, wherein the digitized table resembles the original table.

In a second aspect, disclosed is a system comprising: at least one processing unit; and at least one memory storing computer executable instructions that, when executed by the at least one processing unit, cause the system to perform a method, the method comprising: receiving, at a server device, an image of an original table; recognizing, at the server device, one or more aspects of the original table; generating a digitized table that resembles the original table; and providing, by the server device, the digitized table to an application.

In a third aspect, disclosed is a system comprising: at least one processing unit; and at least one memory storing computer executable instructions that, when executed by the at least one processing unit, cause the system to perform a method, the method comprising: receiving an image of an original table; recognizing one or more aspects of the original table; displaying a preview of a digitized table; and generating the digitized table, wherein the digitized table resembles the original table; wherein recognizing the one or more aspects of the original table further comprises: recognizing a structure of the original table; recognizing one or more values stored in the original table; and recognizing formatting applied to the original table.

### BRIEF DESCRIPTION OF THE DRAWINGS

FIG. 1 illustrates a system for capturing a photograph of a table and recognizing the table and contents therein, according to an example embodiment.

FIG. 2 illustrates an exemplary diagram of a computing device used to capture a photo of a table embedded in a document.

FIG. 3 illustrates a photograph captured of a table from the optical recognition application.

FIG. 4 illustrates a preview mode displaying a digitized version of the table captured in FIG. 3.

FIG. 5 illustrates a user interface used to export the table to a digital editor or viewer application.

FIG. 6 illustrates an example spreadsheet application to which the optically recognized table is exported.

FIG. 7 illustrates a method for optically recognizing a table printed in a document.

FIG. 8 is a block diagram illustrating physical components (e.g., hardware) of a computing device with which aspects of the disclosure may be practiced.

FIG. 9A and FIG. 9B illustrate a mobile computing device, for example, a mobile telephone, a smart phone, wearable computer (such as a smart watch), a tablet computer, a laptop computer, and the like, with which embodiments of the disclosure may be practiced.

FIG. 10 illustrates one aspect of the architecture of a system for processing data received at a computing system from a remote source, such as a general computing device (e.g., personal computer), tablet computing device, or mobile computing device.

FIG. 11 illustrates an exemplary tablet computing device that may execute one or more aspects disclosed herein.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

Generally, the present disclosure is directed to a method for optically capturing an image of a table (e.g., a spreadsheet, a datasheet, or a data table) that is printed on a document (e.g., printed on paper, printed in a text book, printed in a picture, etc.), recognizing the table, and converting the table to a digitized format so that it can be imported into an application that supports tables, such as, for example, a spreadsheet application, a word processing application, a presentation application, etc. In particular, the present disclosure relates to a method for optically recognizing and identifying a structure of a table including individual cells, columns, rows, headers, etc., as the values stored in the table including, for example, characters (e.g., words and numbers), source (e.g., handwritten or typed), language, font, dates (e.g., long or short style), text alignment, number types, etc. Furthermore, aspects of the present disclosure also recognize formatting applied to the original table including, for example, general formatting (bold, underline, italics), shading, cell borders, colors, effects, etc. Digitization of an optically recognized table that is printed on a document therefore allows users to easily and quickly capture information as originally arranged in a table without having to manually re-create the table. Aspects of this disclosure can be implemented using an optical table recognition application operating on a computing device while other aspects may be applied to stored photos of tables taken from a photo capture device such as a camera. These and other examples will be described in further detail herein.

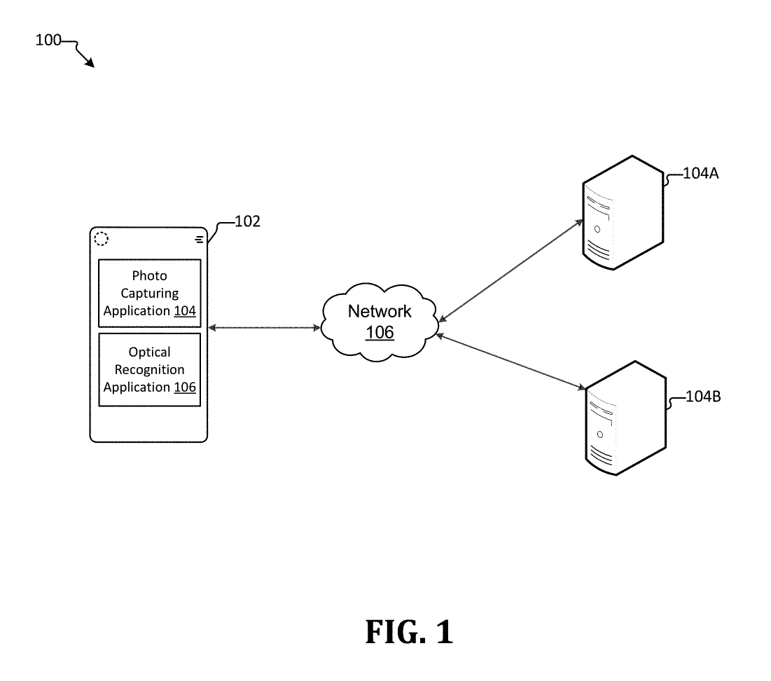

FIG. 1 illustrates an example system 100 for capturing a photograph of a table and recognizing the table and contents therein.

As illustrated, system 100 may include one or more client computing devices 102 that may execute one or more photo capturing applications 104 (e.g., a camera application, a social media application, or other application that executes a camera on the computing device 102), or an optical table recognition application 106 that may also execute a camera on the computing device 102. The client computing device 102 may therefore capture an image of a table. The client computing device 102 may further include a storage device that can store one or more images of the table. In some embodiments, the client computing device 102 stores an image of a table captured by another device.

In some examples, the optical table recognition application 106 may execute locally on a client computing device 102. Alternatively or additionally, the optical table recognition application 106 may operate on one or more server computing devices. In such embodiments, the one or more client computing devices 102 may remotely access, e.g., via a browser over a network (e.g., network 106), the optical table recognition application 106 implemented on a server computing device or multiple server computing devices (e.g., in a distributed computing environment such as a cloud computing environment).

As will be described in further detail herein, the optical recognition application 106 may perform one or more of image capture of a table, analysis on the captured image, optical recognition of the table, translation of the table captured in the image to a table, lookup of additional information, etc. In some embodiments, an optical recognition application may not be used, and instead, a server or other computing device may provide some functionality independent of a single application.

In a basic configuration, the one or more client computing devices 102 are personal or handheld computers having both input elements and output elements operated by one or more users. For example, the one or more client computing devices 102 may include one or more of: a mobile telephone; a smart phone; a tablet; a phablet; a smart watch; a wearable computer; a personal computer; a desktop computer; a laptop computer; a gaming device/computer (e.g., Xbox®); a television; and the like. This list is exemplary only and should not be considered as limiting. Any suitable client computing device for executing a client spreadsheet application and/or remotely accessing spreadsheet application may be utilized.

In some aspects, network 106 is a computer network such as an enterprise intranet and/or the Internet. In this regard, the network 106 may include a Local Area Network (LAN), a Wide Area Network (WAN), the Internet, wireless and wired transmission mediums. In further aspects, server computing devices as described herein may communicate with some components of the system via a local network (e.g., an enterprise intranet), whereas such server computing devices may communicate with other components of the system via a wide area network (e.g., the Internet). In addition, the aspects and functionalities described herein may operate over distributed systems (e.g., cloud computing systems), where application functionality, memory, data storage and retrieval, and various processing functions may be operated remotely from each other over a distributed computing network, such as the Internet or an intranet.

As described herein, the optical table recognition application 106 may be implemented on a server computing device (e.g., server computing device 104A and 104B). In a basic configuration, server computing device 104 may include at least a processing unit and a system memory for executing computer-readable instructions. In some aspects, server computing device 104 may comprise one or more server computing devices 104 in a distributed environment (e.g., cloud computing environment).

As should be appreciated, the various devices, components, etc., described with respect to FIG. 1 are not intended to limit the systems and methods to the particular components described. Accordingly, additional topology configurations may be used to practice the methods and systems herein and/or some components described may be excluded without departing from the methods and systems disclosed herein.

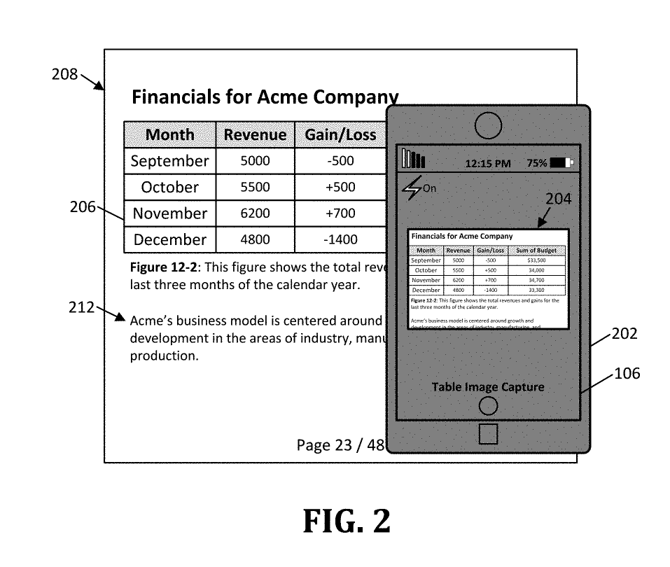

FIG. 2 illustrates an exemplary diagram of a computing device used to capture a photo of a table embedded in a document.

More specifically, FIG. 2 illustrates a camera on a mobile device 202 capturing a photograph 204 of a table 206 printed on a document 208. In this example, the photograph 104 is captured using an optical table recognition application 106 executing on the mobile device 102. However, as described herein, it is understood that the disclosed table optical recognition application 106 may also be executed on any other suitable computing device such as the one or more server computing devices illustrated in FIG. 1. Furthermore, although some examples provided herein describe the use of an optical table recognition application 106 to capture images of a table, it is understood that these descriptions are exemplary and should not be construed as being limited to only the embodiment in which a table is captured. In other embodiments, an image of a table may be captured using a camera application or an image of a table. Alternatively or additionally, the methods and systems described herein may be applied to images of tables that are stored elsewhere (e.g., the Internet or previously captured and stored in memory). Such images may also be optically recognized using the methods and systems described herein.

As described herein, the optical recognition application 106 may perform one or more functions. In some embodiments, the optical recognition application 106 may capture an image of a table, analyze the captured image, optically recognize of the table, optically recognize text or images that are part of the captured image of the table, look-up of additional information, translate recognized text to digital text, etc. In some embodiments, an optical recognition application may not be used, and instead, a server or other computing device may provide some functionality independent of a single application.

Referring back to FIG. 2, in this example, the table 206 printed on a document 208 is captured in the photograph 204 by the optical recognition application 106. In some embodiments, the optical recognition application 106 may capture a photograph of a typed table or a handwritten table. Furthermore, the table may be provided on paper, in a text book, on the display of a computing device, a photograph, etc. Thus, the disclosed optical recognition application 106 can recognize tables of many different forms provided on different mediums.

Furthermore, the optical recognition application 106 can stitch multiple images together to recognize a single table. In some examples, a large table cannot be captured using a single image. Accordingly, multiple images may be captured and the optical recognition application 106 may stitch those images together to recognize and generate a single table using image stitching techniques. In some embodiments, the optical recognition application 106 can recognize a table from a panoramic photograph captured of the table. In other embodiments, the optical recognition application 106 can recognize a table from a video captured of the table. In such embodiments, the optical recognition application 106 may capture a video of a table that may span one or multiple pages.

In this example, the table 206 is printed on a document and adjacent to a text caption 212. The disclosed optical recognition application 106 can further recognize a table that is surrounded or encumbered by text, figures, and other document effects. Accordingly, aspects further provide the digitization of a table 206 using enhanced recognition techniques to distinguish surrounding text or other images from the table 206. Furthermore, because the table 206 may be provided in various documents such as, for example, a book, it is understood that such documents may be bound, and hence have curves or other contours such as bumps or folds. Accordingly, the photograph 204 of the table 206 may also contain such contours. As will be described in further detail herein, although the photograph 204 of the table 206 contains contours, the optical recognition application 106 can recognize the table and digitize the table despite such unevenness in the captured photograph.

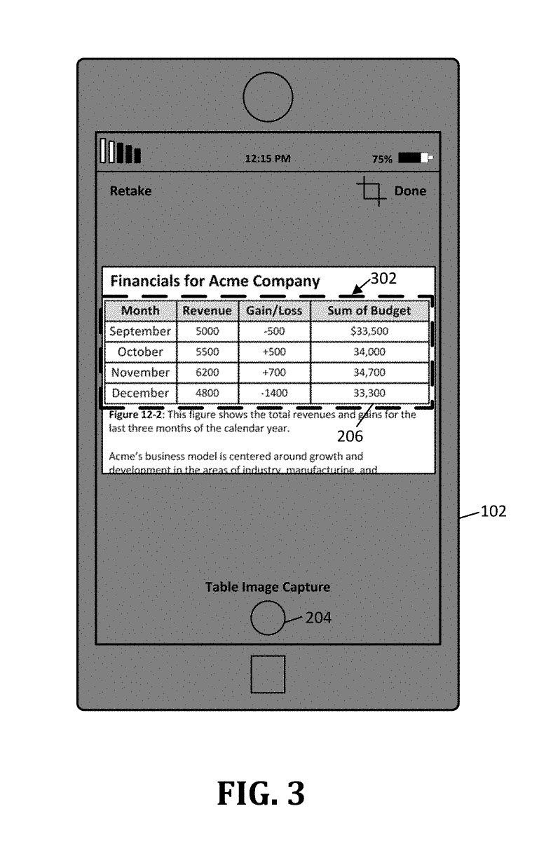

FIG. 3 illustrates a photograph captured of a table 206 from the optical recognition application 106.

As illustrated in the example of FIG. 2, a user may capture a photograph of a table 206 using the optical recognition application 106. In some embodiments, the document 208 within which the table 206 is provided may have text or images outside the table 2. Accordingly, the example illustrated in FIG. 3 contemplates the use of a selection area 302 (represented by dashed lines) that is used to assist in identifying the table 206. In some embodiments, based on a user's selection of an option to show the selection area 302, the selection area 302 may be presented on the display to identify the location and size of the table. In other embodiments, the selection area 302 is presented automatically in response to activation of the optical table recognition application 106 or in response to selection of an image. The example selection area 302 may be used to identify the outer borders of the table 206. In one example, the selection area 302 may be displayed prior to capturing the photograph 104 of the table 206. In such an example, the selection area 302 may be used to more accurately identify the location and size of the table that is to be photographed. In an embodiment, based on a selection of a table image capture option, a photograph of the table 206, as positioned within the selection area, may be captured. Alternatively, in another example, the selection area 302 may be used to select the table 206 within an already captured photograph 104. In either example, the selection area 302 may be float around the display of the device 102 and be repositioned and resized in order to more accurately refine the boundaries of the table. Accordingly, the selection area 302 may be used to identify a table 206 or even a portion thereof. In particular, the selection area 302 may be used to crop certain portions of the table, such as, for example, one or more columns or rows.

Alternatively or additionally, the optical table recognition application 106 may identify the boundaries of the table as well as individual cells within the table, either before or after capturing an image of the table without the use of a selection area 302. In some embodiments, the optical table recognition application 106 may recognize the generally linear horizontal and vertical lines that comprise a table. The table optical recognition application 106 may further identify the column headers based on shading, font size, recognition of a top or outermost cell, etc. The table optical recognition application 106 may also recognize each cell based on relative positions of data between cells. Tables are generally aligned such that data in a single column or a single row align. Accordingly, an image technique that separates data between columns and rows to identify distinct cells of the table may also be used. Similarly, cells can be differentiated by different font types, font sizes, or font effects (bold, underline, italics, etc.), shading, highlighting, etc. applied to various cells. For example, a first column may be shaded in blue while an adjacent column is shaded in red. Accordingly, two separate columns may be recognized and distinct cells may be identified based on any combination of the described image processing techniques. Accordingly, using enhanced image identification techniques, an optical recognition application 106 may recognize table boundaries, individual cells, and data within the table. It is understood that such image recognition techniques may also be employed with the selection area 302 implementation. It is further understood that the data within cells of the table may also be recognized using known OCR techniques.

In addition to identifying columns, rows, and the general boundaries of a table, the optical recognition application 106 may identify other features of a table structure such as, for example, merged areas, cell alignment, column or row headers, formatting, borders, shading, cell effects, font, and styling.

Furthermore, in addition to identifying characters (e.g., words and numbers) stored in the table, the optical recognition application 106 may identify other features of the contents of the table. For example, the optical recognition application 106 may further identify language, font, date formats (e.g., long date, short date format), horizontally positioned text, vertically positioned text, and general text alignment. Furthermore, the optical recognition application 106 may identify number styles such as, for example, currency, percentages, decimal places, units, etc.

Additionally, the optical recognition application 106 may further identify various formulas applied to the table. In some embodiments, the optical recognition application 106 may identify such formulas through recognizing a URL, QR code, or bar code, for example, that is positioned near the original table and that may lead to a website that provides further information about the table. In other embodiments, the optical recognition application 106 may recognize patterns in the data. For example, a row that captures the totals of one or more columns may be recognized by the optical recognition application 106 based on, for example, summing up each of the values in that column to arrive at a particular number provided in the final row, and further recognizing that adjacent cells in that row are also totals. Alternatively or additionally, the optical recognition application 106 may identify formulas based on identifiers in the table. For example, the table may recite the word “Total,” which provides a clue to the optical recognition application 106 that the corresponding row or column is a total row or column and therefore has applied thereon a sum function. In such embodiments, the optical recognition application 106 may recognize a formula.

Still further, optical recognition application 106 may be capable of analyzing the table to identify trends in the data, types of data, and context of the spreadsheet itself to determine more advanced formulas. The optical recognition application 106 may also provide a user interface that allows a user to easily confirm the correctness of the applied formulas (and therefore apply those formulas to the detected cells), remove detected formulas, or edit one or more detected formulas.

In an embodiment, table recognition could also be performed using a bordered table or a borderless table approach, as a non-exclusive example. In a bordered table approach, the system, for example, uses clear borders of a table and any structure around the table to understand that the structured data is a table. In such an example, the system recognizes the table and identifies data in the identified cells. In a borderless table example, the system begins table recognition by first reviewing the cells to determine if the data is a table or if the data is merely laid out in columns or rows.

In yet another embodiment, a mobile device may directly access a spreadsheet application to capture a picture of the table 206. Accordingly, in such an embodiment, the document is understood or assumed to include at least one table of interest. Thus, aspects may include the use of the selection area or other methods to identify a table using a spreadsheet application installed on the photo-capturing device.

In other embodiments, the optical recognition application 106 may be trained over time to recognize aspects of the optical table. It can be trained to recognize types of tables, formats, texts, fonts, etc. over time. Accordingly, the optical recognition application 106 may be trained and, over time, become more accurate at recognizing features of tables. Additionally, the training may help to offer files that contain the tables (e.g., a table offered on a website).

Thus, based on the selection of a table image capture option 204, the optical table recognition application 106 may capture an image of the table 206 and perform image processing on the captured image in order to digitize the table 206.

Although it is described herein as the optical recognition application 106 as performing these functionalities, it is understood that such functionality may be distributed or may be performed on a single device. In an example of a distributed system, some image processing functionality may be performed locally on the client device 102 and other functions may be performed on one or more server computing device (e.g., server computing devices 104). In a single device example, all functionality may be performed on a server computer or a client device.

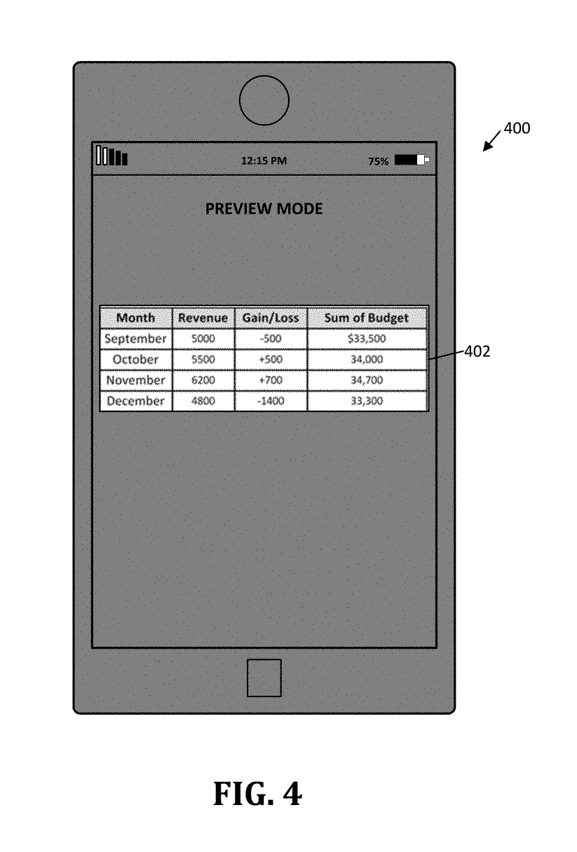

FIG. 4 illustrates a preview mode 400 displaying a digitized version of the table captured in FIG. 3.

In some embodiments, the preview mode 400 of the optical table recognition application 106 displays a digitized version of the table captured from a document or other medium. In this example, the preview mode 400 displays a preview of the digitized table 402 before it is imported or sent to another application.

In some embodiments, the preview mode 400 may display the digitized table 402 with image enhancements applied thereon. Image enhancements may be, for example, brightening, sharpening, and flattening of the underlying table 206 illustrated in FIG. 2 and FIG. 3. In some embodiments, these enhancements may be performed automatically and in other embodiments, these enhancements may be performed in response to a user selection.

Alternatively or additionally, the preview mode 400 may further include the option to select whether to import formatting or styles. As described herein, the original table may have various styles or formatting applied thereto. Accordingly, in the preview mode 400, the user may select whether to apply detected styles or formatting to the digitized table. Furthermore, in some embodiments, the user may wish to only import the styles or formatting applied to the table and not the contents of the table. Accordingly, the preview mode 400 may also provide the option to capture only styles or formatting and ignore the data stored in the table. For example, the user may wish to only import coloring, shading, decimals, grand totals formulas, header layouts, etc. associated with the original table and not to import any of the contents of that original table. Accordingly, the structure of the table and associated styles or formatting may be digitized and imported, leaving out the contents of the original table. In such an example, the user may populate the table with new data, applying the imported features of the table. In other embodiments, the user may even populate the table with new contents from the preview mode 400. Likewise, the preview mode 400 may provide the option to only capture the contents of the original table and to omit any styling or formatting applied to the original table.

Alternatively or additionally, the preview mode 400 may further include an option to edit the digitized table 402, including the structure of the table or the contents therein. In an example, the preview mode 400 may provide the option to leave out one or more columns, rows, or contents from the digitized table 300. Alternatively or additionally, the preview mode 400 may allow the user to edit contents of the digitized table 402, edit formatting applied to the digitized table 402, or edit formulas detected and applied to the digitized table 402. In some embodiments, the user may ink in any edits to the table using an inking feature of the computing device 102. In embodiments, the optical table recognition application 106 may recognize and digitize the inked input and insert it into the digitized table 402.

The preview mode 400 may further provide the option to edit imported formulas. As described herein, formulas may be detected by the optical recognition application 106, so the preview mode 400 may also provide the user with the ability to verify, edit, or remove applied formulas. Alternatively or additionally, the preview mode 400 may provide the ability to even add formulas that were not detected by the optical recognition application 106 or not present in the original table. Likewise, the preview mode 400 may provide the option to edit or remove conditional formatting detected by the optical recognition application 106. Alternatively or additionally, the preview mode 400 may provide the ability to even add conditional formatting not detected by the optical recognition application 106 or not present in the original table.

The preview mode 400 may further provide the option to import detected metadata into the digitized table 402. In an example, metadata may be detected by detection of hyperlinks on the page in which the original table is provided. In other embodiments, metadata may be detected from an associated QR code, bar code, or other identifying features. The preview mode 400 may provide the user with the option to import such metadata into the digitized table 300. In other embodiments, the preview mode 400 may provide the user with the option to import, as metadata, detected images or text associated with the table, but not stored in the table (e.g., images, captions, or table descriptions provided near and associated with the original table).

Furthermore, URLs, QR codes, bar codes, etc. may be provided near the original table that may lead to more recent information. Accordingly, any such URLs, QR codes, bar codes, etc. that are detected during the photo capture process may be followed and used to verify the contents of the table, or to update the contents of the table with the most recent information. Additionally or alternatively, such URLs, QR codes, bar codes, etc. may provide the option to pull in additional data from a website with which the link or code is associated. In an example, a URL may lead to a website that stores additional pricing information, a company name, or any information related to the table. The preview mode 400 may thus provide the option to import such additional information and provide the user with the ability to preview the table with the imported information. In some embodiments, the user may select where the imported information is to be stored in the table (e.g., added to a new column/row, or to an existing cell, column, or row). In some embodiments, the URL, QR code, or bar code may be saved so that it may be used to follow a path to continually update information or import new information to the digitally recognized table.

In some embodiments, the preview mode 400 may further provide the option to translate the text of contents of the original table into another language. For example, a table may be written in Mandarin and the optical recognition application 106 may provide the option to translate it to English or another language. In some embodiments, this may be performed during processing and the digitized table may be automatically provided in the translated form, and in other embodiments, the contents may be translated based on selection of a translation option.

In some embodiments, the preview mode 400 may further provide a confidence factor, such as low, medium, or high confidence (or any other scale, such as percentage or other numerical scale) that describes the confidence level of the accuracy of the contents and structure recognized by the optical recognition application 106, as compared with the original table. This confidence factor may depend on many variables, including, for example, the form of the original table (e.g., type or handwritten), the font size of the contents within the table, etc. If the optical recognition application 106 flags the accuracy level as being low or below a predetermined threshold, the optical recognition application 106 may flag the accuracy so the user can further review. In some embodiments, the optical recognition application 106 may provide one or more alternatively recognized tables.

Although these options are described as being provided in the preview mode 400, these options may be provided at any stage of the digitization and import process. For example, the options to capture styles or metadata may be selected prior to image capture, or they may be selected once the table is imported to the desired application.

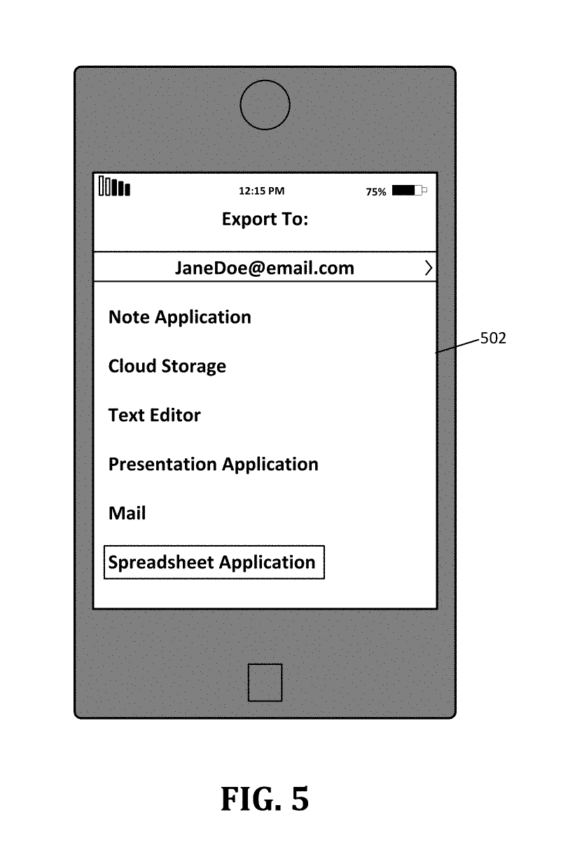

FIG. 5 illustrates a user interface 502 used to export the table to a digital editor or viewer application.

The digitized table 502 including the table structure and values stored therein may be stored in a digital format such that the digital information may be exported to an application such as, for example, a note-taking application, a text editor, a presentation application, an email application, or a spreadsheet application. Alternatively or additionally, the digitized table may be stored in a storage device local to the device or may be stored in a cloud storage device or a database accessible over a network. Alternatively or additionally, the digital information representing the table and contents contained therein may be exported to a cloud storage device.

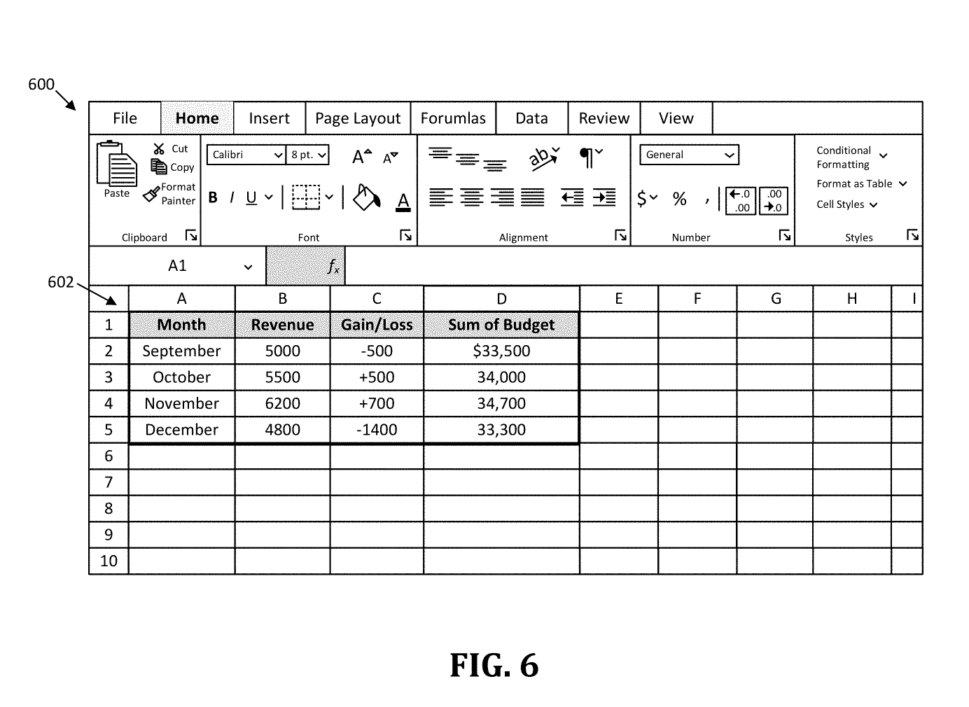

FIG. 6 illustrates an example spreadsheet application 600 to which the optically recognized table is exported.

As illustrated, the original table 206 illustrated in FIG. 2 is now arranged as a digital table 602 in the spreadsheet application 600. In addition, the relative arrangement of the cells, the font type, and the font effects of the original table 206 are maintained in the digital table 602.

Accordingly, disclosed are systems and methods for optically recognizing a table printed in a document, wherein the optical recognition includes, among other features, recognizing the table boundaries, cell boundaries, values, column and row headers, cell effects, etc. The optically recognized table may be exported to one of many applications in which a user wishes to view or edit the table. Accordingly, aspects eliminate the need to manually enter data into a table and format that table.

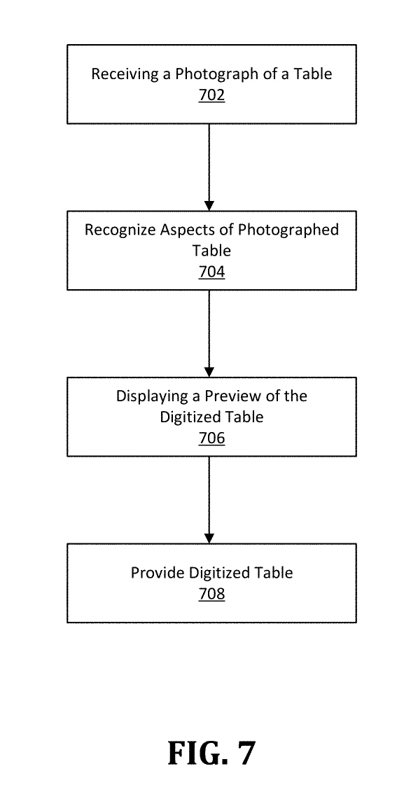

FIG. 7 illustrates a method 700 for optically recognizing a table printed in a document.

In some embodiments, the method 700 is performed by an optical recognition application such as optical recognition application 106 described herein. The method 700 starts at operation 702 in which a photograph of the table is received by the optical recognition application. As described herein, a photograph of a printed table or even a photograph of a digital table may be captured using a camera of a device, such as a mobile device or other suitable computing device. In some embodiments, the photograph is captured using the optical recognition application 106. In other embodiments, the photograph has already been captured (e.g., the image may be stored in memory or may be from an external source) and is uploaded to the optical recognition application 106.

As described herein, the table may be printed in a document, such as, on a piece of paper, in a text book, in a brochure, etc. In some embodiments, the table is displayed on the display of another device, such as stored as a photo on another device, displayed on a website, etc. In some embodiments, the table may be printed over multiple pages. Alternatively or additionally, the table may be too large for a single picture. Accordingly, multiple photographs can be taken of a table, wherein the optical recognition application 106 may stitch the photos together to generate a single, digitized table. Alternatively or additionally, a video may be taken of a table, wherein frames from the video may be used to stitch together the images of the table.

In operation 704, the optical recognition application 106 recognizes aspects of the photographed table. For example, the optical recognition application 106 recognizes the table structure such as the outer border of the table, including the number of rows, and columns of the table. As described herein, in some embodiments, this may be done using a selection area such as selection area 402. The optical recognition application 106 further recognizes the values stored in the table, such as the numbers, letters, words, etc. The optical recognition application 106 further recognizes formatting and style, such as font, bold, underline, italics, shading, colors, fill effects, cell text alignment, units, decimals, percentages, dates, languages, etc. In some embodiments, formulas may be recognized. In some embodiments, the optical recognition application 106 further recognizes supplemental information that is not part of the table, but associated to the table such as a URL, QR code, or bar code that may lead to further information related to the photographed table. As described herein, formulas may be recognized by analyzing key words (e.g., “Grand Total,” “%,” “Rate” etc.) in headers or other cells. Alternatively or additionally, the optical recognition application 106 may use a URL, QR code, or bar code to learn more information about a table. Alternatively or additionally, the optical recognition application 106 may identify trends or patterns of the values in the table and correlate such trends or patterns to a particular formula. The optical recognition application 106 may further recognize any conditional formatting applied to the table. In some embodiments, the optical recognition application 106 may recognize metadata from the image.

In operation 706, the optical recognition application 106 displays a preview of the digitized table. In some embodiments, operation 606 is optional, as indicated by the dashed line. The preview may allow the user to understand what the digitized table looks like and even allows the user to edit the table. In some embodiments, the preview mode may provide the option to select whether to import any of the recognized features in operation 604. For example, the preview mode may provide the option to import formatting or styles applied to the original table. The preview mode may also provide the option to import the values or just to digitize the table itself without the values. Additionally, the preview mode may provide the option to capture styles, formatting, or formulas that are applied to a table without importing and digitizing the values. Alternatively or additionally, the preview mode may provide the option to only capture the values of the table and not the formatting, styles, or functions. In other embodiments, a combination of such options can be imported. In other embodiments, the preview mode may provide the option to edit recognized formulas and conditional formatting. Alternatively or additionally, in other embodiments, the preview mode may provide the option to add unrecognized formulas and conditional formatting.

Furthermore, the preview mode may provide the option to edit the structure of the table. In an example, the preview mode may provide the option to add or remove columns and rows of the table.

In other embodiments, the preview mode may provide the option to import detected metadata into the digitized table. Alternatively or additionally, the preview mode may provide the option to update or enhance the table based on any associated QR codes, URLs, or bar codes associated with the table and recognized by the optical recognition application 106.

The preview mode may further provide the ability to translate the text of contents stored in the table to another language. In some embodiments, the preview mode may translate the language to a default language and in other embodiments, the preview mode will perform translations in response to a user's selection to translate.

In some embodiments, the preview mode may provide a confidence factor describing the confidence in the accuracy of the digitized table. In some embodiments, the confidence level may be based on the confidence relating to the accuracy of the values, structure, style, formatting, formulas, etc.

In operation 708, the digitized table is provided. The digitized table includes the one or more options selected in the preview mode, for example. In some embodiments, the digitized table is provided in an application selected by the user, such as, for example, a spreadsheet application, a word processing application, a presentation application, or an email application. Alternatively or additionally, the digitized table may be stored locally, on the cloud, or in a remote database.

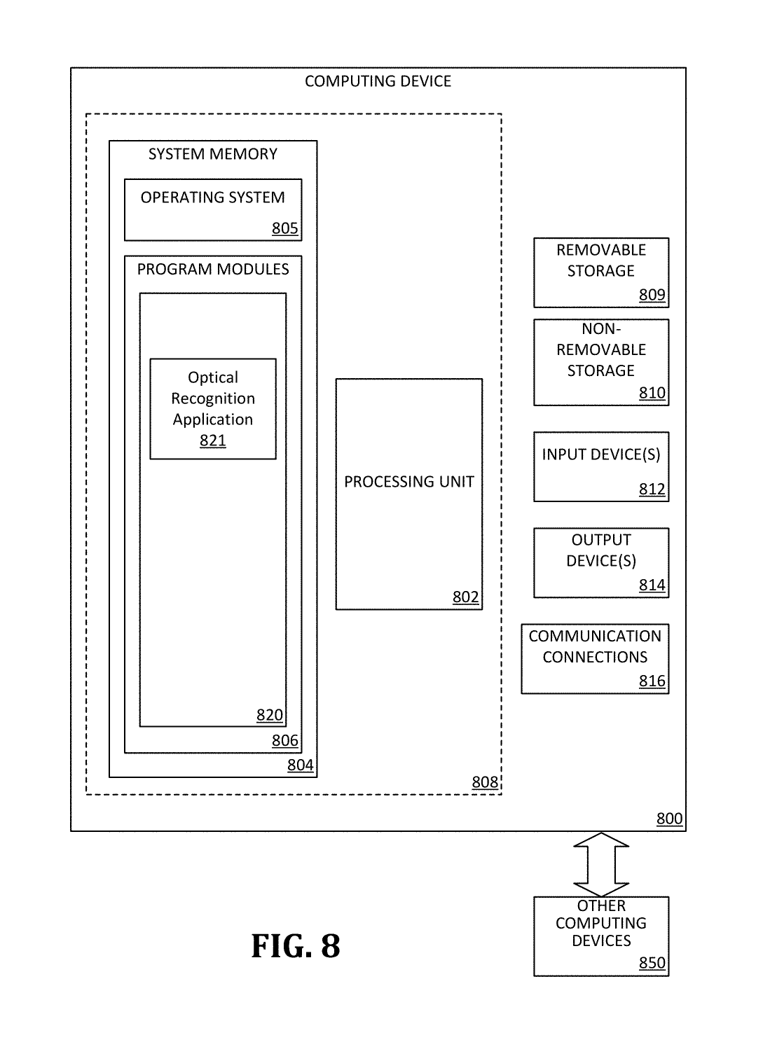

FIGS. 8-11 and the associated descriptions provide a discussion of a variety of operating environments in which aspects of the disclosure may be practiced. However, the devices and systems illustrated and discussed with respect to FIGS. 8-11 are for purposes of example and illustration and are not limiting of a vast number of computing device configurations that may be utilized for practicing aspects of the disclosure, as described herein.

FIG. 8 is a block diagram illustrating physical components (e.g., hardware) of a computing device 800 with which aspects of the disclosure may be practiced.

The computing device components described below may have computer executable instructions for implementing an optical recognition application 821 on a computing device (e.g., server computing device 108 and/or client computing device 104), including computer executable instructions for optical recognition application 821 that can be executed to implement the methods disclosed herein. In a basic configuration, the computing device 800 may include at least one processing unit 802 and a system memory 804. Depending on the configuration and type of computing device, the system memory 804 may comprise, but is not limited to, volatile storage (e.g., random access memory), non-volatile storage (e.g., read-only memory), flash memory, or any combination of such memories. The system memory 804 may include an operating system 805 and one or more program modules 806 suitable for running optical recognition application 821.

The operating system 805, for example, may be suitable for controlling the operation of the computing device 800. Furthermore, embodiments of the disclosure may be practiced in conjunction with a graphics library, other operating systems, or any other application program and is not limited to any particular application or system. This basic configuration is illustrated in FIG. 8 by those components within a dashed line 808. The computing device 800 may have additional features or functionality. For example, the computing device 800 may also include additional data storage devices (removable and/or non-removable) such as, for example, magnetic disks, optical disks, or tape. Such additional storage is illustrated in FIG. 8 by a removable storage device 809 and a non-removable storage device 810. As stated above, a number of program modules and data files may be stored in the system memory 804. While executing on the processing unit 802, the program modules 806 (e.g., optical recognition application 821) may perform processes including, but not limited to, the aspects, as described herein.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 8 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 800 on the single integrated circuit (chip). Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general purpose computer or in any other circuits or systems.

The computing device 800 may also have one or more input device(s) 812 such as a keyboard, a mouse, a pen, a sound or voice input device, a touch or swipe input device, etc. The output device(s) 814 such as a display, speakers, a printer, etc. may also be included. The aforementioned devices are examples and others may be used. The computing device 800 may include one or more communication connections 816 allowing communications with other computing devices 850. Examples of suitable communication connections 816 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 804, the removable storage device 809, and the non-removable storage device 810 are all computer storage media examples (e.g., memory storage). Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 800. Any such computer storage media may be part of the computing device 800. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

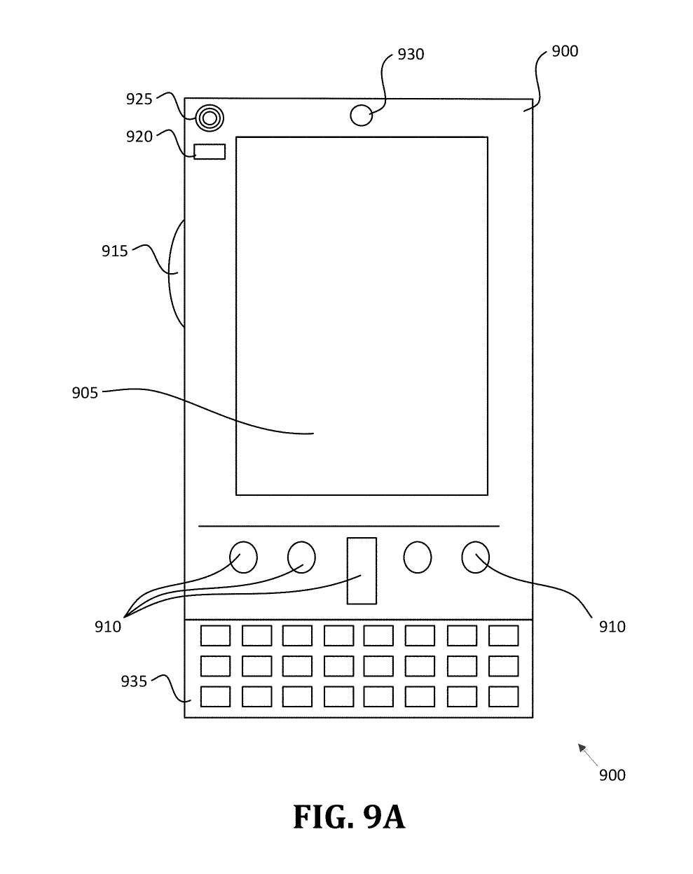

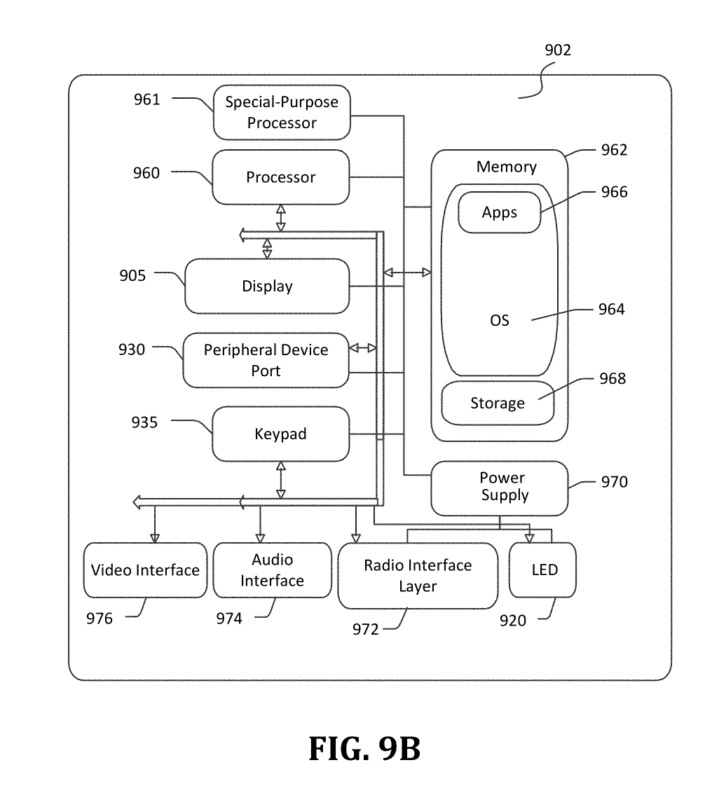

FIG. 9A and FIG. 9B illustrate a mobile computing device 900, for example, a mobile telephone, a smart phone, wearable computer (such as a smart watch), a tablet computer, a laptop computer, and the like, with which embodiments of the disclosure may be practiced.

In some aspects, the client may be a mobile computing device. With reference to FIG. 9A, one aspect of a mobile computing device 900 for implementing the aspects is illustrated. In a basic configuration, the mobile computing device 900 is a handheld computer having both input elements and output elements. The mobile computing device 900 typically includes a display 905 and one or more input buttons 910 that allow the user to enter information into the mobile computing device 900. The display 905 of the mobile computing device 900 may also function as an input device (e.g., a touch screen display). If included, an optional side input element 915 allows further user input. The side input element 915 may be a rotary switch, a button, or any other type of manual input element. In alternative aspects, mobile computing device 900 may incorporate more or less input elements. For example, the display 905 may not be a touch screen in some embodiments. In yet another alternative embodiment, the mobile computing device 900 is a portable phone system, such as a cellular phone. The mobile computing device 900 may also include an optional keypad 935. Optional keypad 935 may be a physical keypad or a “soft” keypad generated on the touch screen display. In various embodiments, the output elements include the display 905 for showing a graphical user interface (GUI), a visual indicator 920 (e.g., a light emitting diode), and/or an audio transducer 925 (e.g., a speaker). In some aspects, the mobile computing device 900 incorporates a vibration transducer for providing the user with tactile feedback. In yet another aspect, the mobile computing device 900 incorporates input and/or output ports, such as an audio input (e.g., a microphone jack), an audio output (e.g., a headphone jack), and a video output (e.g., a HDMI port) for sending signals to or receiving signals from an external device.

FIG. 9B is a block diagram illustrating the architecture of one aspect of a mobile computing device. That is, the mobile computing device 900 can incorporate a system (e.g., an architecture) 902 to implement some aspects. In one embodiment, the system 902 is implemented as a “smart phone” capable of running one or more applications (e.g., browser, e-mail, calendaring, contact managers, messaging clients, games, and media clients/players). In some aspects, the system 902 is integrated as a computing device, such as an integrated personal digital assistant (PDA) and wireless phone.

One or more application programs 966 may be loaded into the memory 962 and run on or in association with the operating system 964. Examples of the application programs include phone dialer programs, e-mail programs, personal information management (PIM) programs, word processing programs, spreadsheet programs, Internet browser programs, messaging programs, and so forth. The system 902 also includes a non-volatile storage area 968 within the memory 962. The non-volatile storage area 968 may be used to store persistent information that should not be lost if the system 902 is powered down. The application programs 966 may use and store information in the non-volatile storage area 968, such as email or other messages used by an email application, and the like. A synchronization application (not shown) also resides on the system 902 and is programmed to interact with a corresponding synchronization application resident on a host computer to keep the information stored in the non-volatile storage area 968 synchronized with corresponding information stored at the host computer. As should be appreciated, other applications may be loaded into the memory 962 and run on the mobile computing device 900, including the instructions for associating one or more images with one or more cells of a spreadsheet as described herein (e.g., field component, associate component, array component, hybrid component, operation component, and/or UX component, etc.).

The system 902 has a power supply 970, which may be implemented as one or more batteries. The power supply 970 may further include an external power source, such as an AC adapter or a powered docking cradle that supplements or recharges the batteries. The system 902 may also include a radio interface layer 972 that performs the function of transmitting and receiving radio frequency communications. The radio interface layer 972 facilitates wireless connectivity between the system 902 and the “outside world,” via a communications carrier or service provider. Transmissions to and from the radio interface layer 972 are conducted under control of the operating system 964. In other words, communications received by the radio interface layer 972 may be disseminated to the application programs 966 via the operating system 964, and vice versa.

The visual indicator 920 may be used to provide visual notifications, and/or an audio interface 974 may be used for producing audible notifications via an audio transducer 925 (e.g., audio transducer 925 illustrated in FIG. 9A). In the illustrated embodiment, the visual indicator 920 is a light emitting diode (LED) and the audio transducer 925 may be a speaker. These devices may be directly coupled to the power supply 970 so that when activated, they remain on for a duration dictated by the notification mechanism even though the processor 960 and other components might shut down for conserving battery power. The LED may be programmed to remain on indefinitely until the user takes action to indicate the powered-on status of the device. The audio interface 974 is used to provide audible signals to and receive audible signals from the user. For example, in addition to being coupled to the audio transducer 925, the audio interface 974 may also be coupled to a microphone to receive audible input, such as to facilitate a telephone conversation. In accordance with embodiments of the present disclosure, the microphone may also serve as an audio sensor to facilitate control of notifications, as will be described below. The system 902 may further include a video interface 976 that enables an operation of peripheral device 930 (e.g., on-board camera) to record still images, video stream, and the like.

A mobile computing device 900 implementing the system 902 may have additional features or functionality. For example, the mobile computing device 900 may also include additional data storage devices (removable and/or non-removable) such as, magnetic disks, optical disks, or tape. Such additional storage is illustrated in FIG. 9B by the non-volatile storage area 968.

Data/information generated or captured by the mobile computing device 900 and stored via the system 902 may be stored locally on the mobile computing device 900, as described above, or the data may be stored on any number of storage media that may be accessed by the device via the radio interface layer 972 or via a wired connection between the mobile computing device 900 and a separate computing device associated with the mobile computing device 900, for example, a server computer in a distributed computing network, such as the Internet. As should be appreciated such data/information may be accessed via the mobile computing device 900 via the radio interface layer 972 or via a distributed computing network. Similarly, such data/information may be readily transferred between computing devices for storage and use according to well-known data/information transfer and storage means, including electronic mail and collaborative data/information sharing systems.

As should be appreciated, FIGS. 9A and 9B are described for purposes of illustrating the present methods and systems and is not intended to limit the disclosure to a particular sequence of steps or a particular combination of hardware or software components.

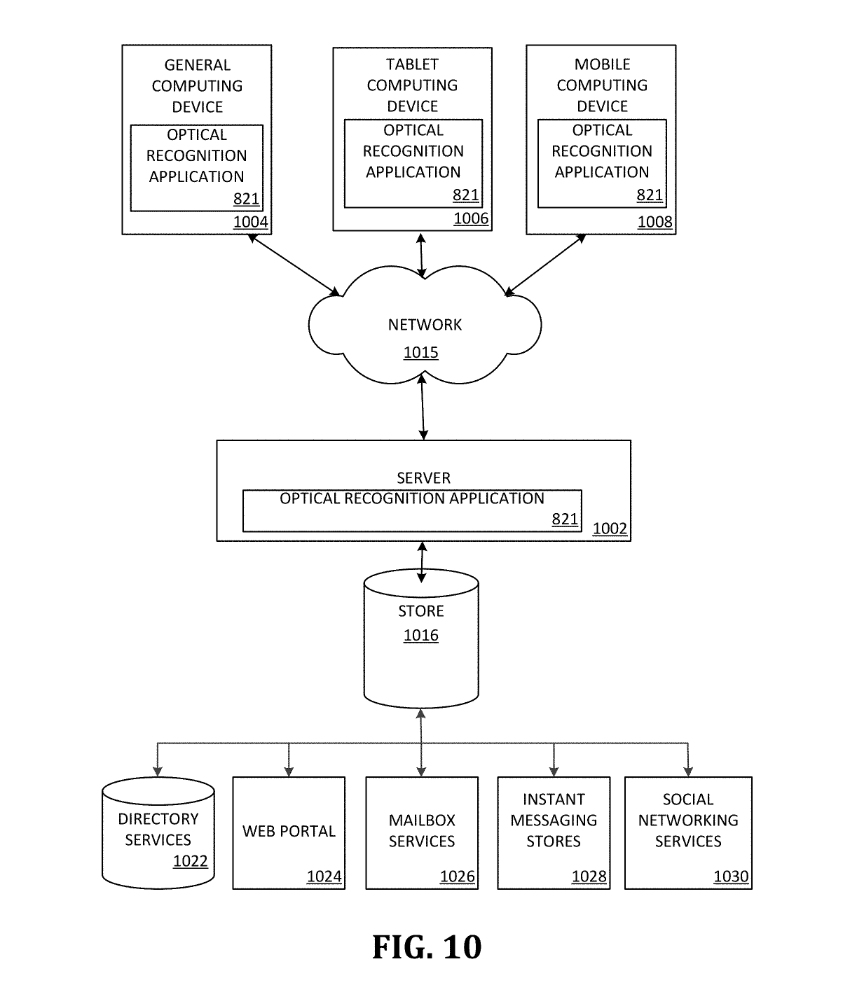

FIG. 10 illustrates one aspect of the architecture of a system for processing data received at a computing system from a remote source, such as a general computing device 1004 (e.g., personal computer), tablet computing device 1006, or mobile computing device 1008, as described above.

Content displayed at server device 1002 may be stored in different communication channels or other storage types. For example, various documents may be stored using a directory service 1022, a web portal 1024, a mailbox service 1026, an instant messaging store 1028, or a social networking service 1030. The optical recognition application 821 may be employed by a client that communicates with server device 1002, and/or the optical recognition 821 may be employed by server device 1002. The server device 902 may provide data to and from a client computing device such as a general computing device 1004, a tablet computing device 1006 and/or a mobile computing device 1008 (e.g., a smart phone) through a network 1015. By way of example, the computer system described above may be embodied in a general computing device 1004 (e.g., personal computer), a tablet computing device 1006 and/or a mobile computing device 1008 (e.g., a smart phone). Any of these embodiments of the computing devices may obtain content from the store 1016, in addition to receiving graphical data useable to either be pre-processed at a graphic-originating system or post-processed at a receiving computing system.

As should be appreciated, FIG. 10 is described for purposes of illustrating the present methods and systems and is not intended to limit the disclosure to a particular sequence of steps or a particular combination of hardware or software components.

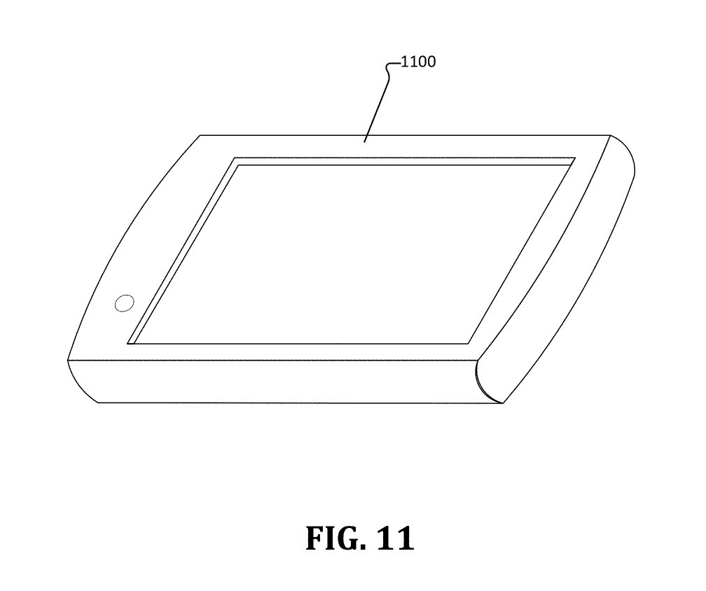

FIG. 11 illustrates an exemplary tablet computing device 1100 that may execute one or more aspects disclosed herein.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As should be appreciated, FIG. 11 is described for purposes of illustrating the present methods and systems and is not intended to limit the disclosure to a particular sequence of steps or a particular combination of hardware or software components.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present disclosure, one skilled in the art may envision variations, modifications, and alternate aspects falling within the spirit of the broader aspects of the general inventive concept embodied in this application that do not depart from the broader scope of the claimed disclosure.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

What is claimed is:

1. A computer-implemented method for optically recognizing a table using an optical recognition application, the method comprising:
receiving an image of an original table;
recognizing one or more aspects of the original table; and
generating a digitized table, wherein the digitized table resembles the original table.

2. The computer-implemented method of claim 1, wherein the original table is provided in a document.

3. The computer-implemented method of claim 1, wherein recognizing the one or more aspects of the original table comprises recognizing a structure of the original table and one or more values in associated cell(s) of the original table.

4. The computer-implemented method of claim 3, wherein recognizing the one or more aspects of the original table further comprises:
recognizing formatting applied to the original table.

5. The computer-implemented method of claim 4, wherein recognizing formatting applied to the original table further comprises recognizing at least one of:
a style applied to the one or more values, a format applied to the one or more values, an alignment of the one or more values, a language in which at least one of the one or more value is written, and colors applied to the one or more values.

6. The computer-implemented method of claim 1, further comprising displaying a preview of the digitized table.

7. The computer-implemented method of claim 6, wherein displaying the preview of the digitized table comprises displaying the original table in a digitized format.

8. The computer-implemented method of claim 6, wherein displaying the preview of the digitized table further comprises displaying a confidence level describing an accuracy of the digitized table.

9. The computer-implemented method of claim 1, further comprising:
displaying an option to import at least one of formatting and style applied to the original table.

10. The computer-implemented method of claim 1, further comprising:
displaying an option to edit at least one of: the structure of the digitized table and one or more values of the digitized table.

11. The computer-implemented method of claim 1, further comprising:
displaying an option to import one or more formulas included in the original table.

12. The computer-implemented method of claim 1, further comprising:
displaying an option to import metadata associated with the original table.

13. The computer-implemented method of claim 1, wherein receiving the image further includes receiving one image, the one image including an entire view of the table.

14. The computer-implemented method of claim 1, wherein receiving the image further includes receiving two or more images, wherein each of the two or more images are stitched together to generate the digitized table.

15. The computer-implemented method of claim 1, further comprising:
exporting the digitized table to a spreadsheet application.

16. A system comprising:
at least one processing unit; and
at least one memory storing computer executable instructions that, when executed by the at least one processing unit, cause the system to perform a method, the method comprising:
receiving, at a server device, an image of an original table;
recognizing, at the server device, one or more aspects of the original table;
generating a digitized table that resembles the original table; and
providing, by the server device, the digitized table to an application.

17. The system of claim 16, further comprising:
providing a preview of the digitized table.

18. The system of claim 16, wherein recognizing the one or more aspects of the original table further comprises:
recognizing a structure of the original table; and
recognizing one or more values stored in the original table.

19. The system of claim 16, wherein recognizing the one or more aspects of the original table further comprises:
recognizing aspects of the original table based on training data.

20. A system comprising:
at least one processing unit; and
at least one memory storing computer executable instructions that, when executed by the at least one processing unit, cause the system to perform a method, the method comprising:
receiving an image of an original table;
recognizing one or more aspects of the original table;
displaying a preview of a digitized table; and
generating the digitized table, wherein the digitized table resembles the original table;
wherein recognizing the one or more aspects of the original table further comprises:
recognizing a structure of the original table;
recognizing one or more values stored in the original table; and
recognizing formatting applied to the original table.
